(19) United States
(12) Patent Application Publication
(10) Pub. No.: US 2007/0255964 A1
(43) Pub. Date: Nov. 1, 2007

(54) System and method of implementing security for a docked data processing system

(76) Inventors: Susann M. Keohane, Austin, TX (US); Gerald F. McBrearty, Austin, TX (US); Shawn P. Mullen, Buda, TX (US); Jessica Murillo, Round Rock, TX (US); Johnny M. Shieh, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/412,814

(22) Filed: Apr. 27, 2006

(51) Int. Cl. G06F 12/14

(52) U.S. Cl. 713/193

(57) ABSTRACT

A system, method, and computer-usable medium for detecting movement of a portable computer; comparing the detected movement of the portable computer to a predetermined threshold; determining if the portable computer is coupled to a docking station; and in response to determining the portable computer is coupled to the docking station, enabling security to secure data stored on the portable computer.

### BACKGROUND OF THE INVENTION

1. Technical Field

The present invention relates in general to the field of data processing systems. More particularly, the present invention relates to the field of securing data stored on data processing systems. Still more particularly, the present invention relates to a system and method of implementing security for a docked data processing system.

2. Description of the Related Art

Laptop computers are inherently portable. In today's business world, portable computing has become a cost-efficient reality with the advent of affordable, near-desktop performance in a laptop computer. However, portability of laptop computer systems facilitates theft of not only the physical hardware, but often confidential and sensitive data stored on the stolen laptop computer.

Those with skill in the art will appreciate that modern laptop computers may be interfaced with “docking stations” to facilitate home or office use. Since the design of many laptop computers emphasize minimizing the size and weight of the computer, some laptops utilize interfaces that save space when traveling, but are very inconvenient in an office or home setting. For example, a user may want to interface a full-size keyboard, mouse, optical drive, floppy disk drive, external hard drive, etc. with the laptop computer. A docking station enables a laptop computer to emulate a desktop computer by providing access such resources.

Even though laptop computers are interfaced with docking stations, they are still susceptible to theft. Therefore, there is a need for a system and method for addressing the aforementioned limitation.

### SUMMARY OF THE INVENTION

The present invention includes a system, method, and computer-usable medium for detecting movement of a portable computer; comparing the detected movement of the portable computer to a predetermined threshold; determining if the portable computer is coupled to a docking station; and in response to determining the portable computer is coupled to the docking station, enabling security to secure data stored on the portable computer.

The above, as well as additional purposes, features, and advantages of the present invention will become apparent in the following detailed written description

### BRIEF DESCRIPTION OF THE FIGURES

The novel features believed characteristic of the inventions are set forth in the appended claims. The invention itself, however, as well as a preferred mode of use, further purposes and advantages thereof, will best be understood by reference to the following detailed description of an illustrative embodiment when read in conjunction with the accompanying figures, wherein:

FIG. 1A is a pictorial representation of an exemplary data processing system in which a preferred embodiment of the present invention may be implemented;

FIG. 1B is a block diagram illustrating an exemplary data processing system in which a preferred embodiment of the present invention may be implemented; and

FIG. 2 is a high-level logical flowchart diagram illustrating an exemplary method of implementing security for a docked data processing system according to a preferred embodiment of the present invention.

### DETAILED DESCRIPTION OF A PREFERRED EMBODIMENT

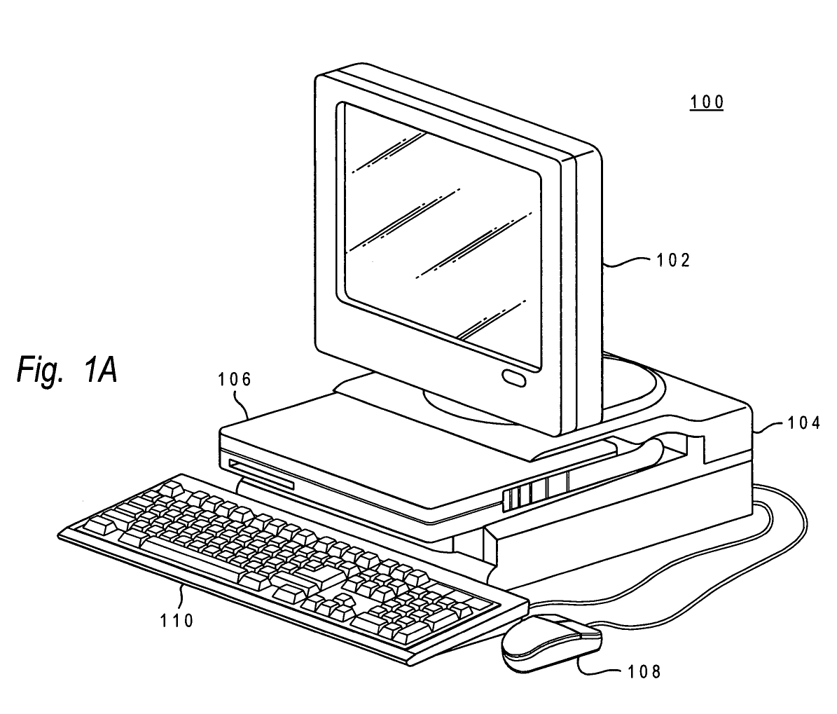

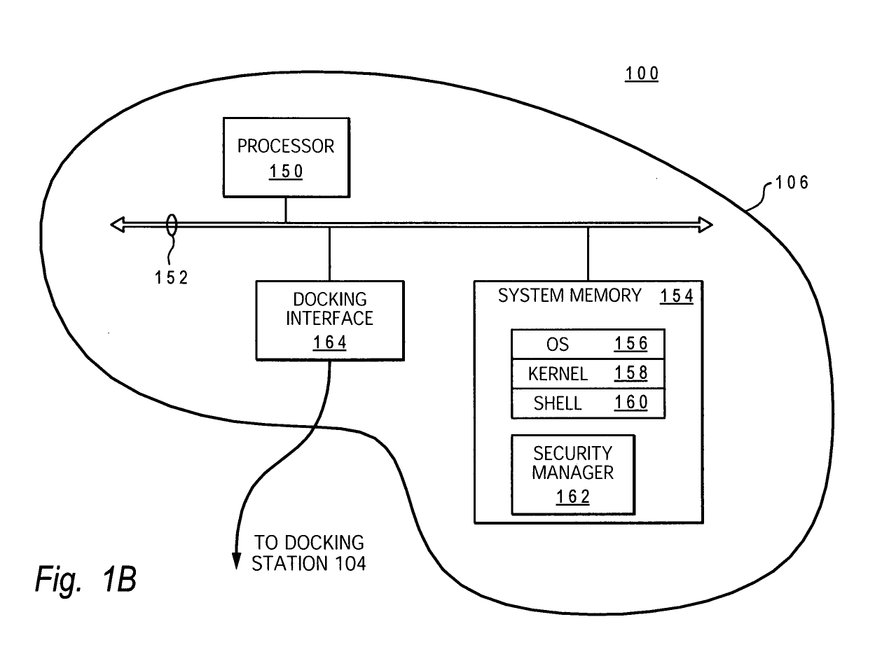

Referring now to the figures, and in particular, referring to FIG. 1A, there is a pictorial representation of data processing system 100 in which a preferred embodiment of the present invention may be implemented. As illustrated, data processing system 100 includes monitor 102, docking station 104, portable computer 106, mouse 108, and keyboard 110. In a preferred embodiment of the present invention, portable computer 106 can be implemented as a laptop computer that emulates a desktop computer when coupled with docking station 104. For example, a user can interface with portable computer 106 utilizing mouse 108 and keyboard 110. The user can view the results of the portable computer 106's processing utilizing monitor 102. The docked configuration implies that the user does not desire to take advantage of the portable features of portable computer 106 and does not plan to move data processing system 100 in the foreseeable future.

Those with skill in the art will appreciate that data processing system 100 may be implemented with any type of computer and docking system FIG. 1A does not imply any architectural limitations on the present invention.

FIG. 1B is a block diagram illustrating an exemplary data processing system 100 in which a preferred embodiment of the present invention may be implemented. As depicted, portable computer 106 further includes a processor 150, an interconnect 152 coupled to processor 150, a docking interface 164 that couples portable computer 106 to docking station 104, and a system memory 154 coupled to processor 150 via interconnect 152.

As illustrated, system memory 154 includes operating system (OS) 156, which further includes shell 160 for providing transparent user access to resources such as application programs and security manager 162. Generally, shell 160 is a program that provides an interpreter and an interface between the user and the operating system. More specifically, shell 160 executes commands that are entered into a command line user interface or a file. Thus, shell 160 (as it is called in UNIX®), also called a command processor in Windows®, is generally the highest level of the operating system software hierarchy and servers as a command interpreter. The shell provides a system prompt, interprets commands entered by keyboard, mouse, or other user input media, and sends the interpreted command(s) to the appropriate lower levels of the operating system (e.g., kernel 158) for processing. Note that while shell 160 is a text-based, line-oriented user interface, the present invention will support other user interface modes, such as graphical, voice, gestural, etc. equally well.

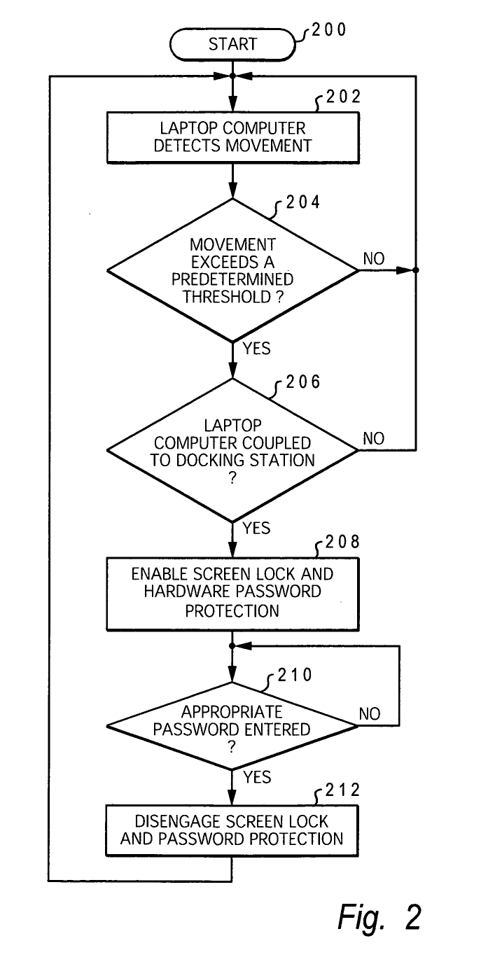

As illustrated, operating system 156 also includes kernel 158, which includes lower levels of functionality for operating system 156, including providing essential services required by other parts of operating system 156 and application programs, including memory management, process and task management, disk management, and mouse and keyboard management. Security manager 162, discussed herein in more detail in conjunction with FIG. 2, detects movement in data processing system 100 and determines whether the detected movement requires security manager 162 to enable security measures to safeguard data stored on data processing system 100 from theft.

FIG. 2 is a high-level logical flowchart depicting an exemplary method of implementing security for a docked data processing system according to a preferred embodiment of the present invention. The process begins at step 200 and proceeds to step 202, which illustrates security manager 162 detecting movement. Those with skill in the art will appreciate that the detection of movement can be accomplished by any means including, but not limited to: utilizing an internal motion sensor, GPS locations, radio frequency identification (RFID) locations, Bluetooth, GPS speed calculated by difference in GPS locations, etc. The process continues to step 204, which depicts security manager 162 determining if the detected movement exceeds a predetermined threshold.

If the detected movement does not exceed a predetermined threshold, the process returns to step 202 and continues in an iterative fashion. However, if the detected movement does exceed a predetermined threshold, the process continues to step 206, which depicts security manager 162 determining if portable computer 106 is coupled to docking station 104. In a preferred embodiment of the present invention, if portable computer 106 is coupled to docking station 104, it is assumed that movement beyond slight movements for position adjustment of the system is abnormal and could be the result of attempted theft of data processing system 100. If, however, portable computer 106 is not coupled to docking station 104, detected movement is probably a result of normal operation of portable computer 106. For example, a user may be changing his or her work location.

If portable computer 106 is not coupled to docking station 104, the process returns to step 202 and continues in an iterative fashion. However, if portable computer 106 is coupled to docking station 206, security manager 162 assumes that an individual is attempting to move the system without authorization. The process continues to step 208, which illustrates security manager 162 enabling screen lock and hardware password protection to protect the data stored on portable computer 106. Those with skill in the art will appreciate that any security measure, including, but not limited to: a screen lock, a password lock, an audible and/or visual alarm, etc. may be utilized and activated in response to determining portable computer 106 is coupled to docking station 104.

The process continues to step 210, which depicts security manager 162 determining if an appropriate password has been entered. If an appropriate password has not been entered, the process iterates at step 210. This assumes that an authorized user of the system has not disengaged the security measures. If an appropriate password has been entered, the process proceeds to step 212 which depicts security manager 162 disengaging the security measures. The process then returns to step 202 and proceeds in an iterative fashion.

As discussed, the present invention includes a system, method, and computer-usable medium for detecting movement of a portable computer; comparing the detected movement of the portable computer to a predetermined threshold; determining if the portable computer is coupled to a docking station; and in response to determining the portable computer is coupled to the docking station, enabling security to secure data stored on the portable computer.

It should be understood that at least some aspects of the present invention may alternatively be implemented in a computer-usable medium that contains a program product. Programs defining functions in the present invention can be delivered to a data storage system or a computer system via a variety of signal-bearing media (e.g., CD-ROM), writable storage media (e.g., hard disk drive, read/write CD-ROM, optical media), system memory such as, but not limited to Random Access Memory (RAM), and communication media such as computer and telephone networks including Ethernet, the Internet, wireless networks, and like network systems. It should be understood, therefore, that such signal-bearing media when carrying or encoding computer-readable instructions that direct method functions in the present invention represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made therein without departing from the spirit and scope of the invention. Furthermore, as used in the specification and the appended claims, the term “computer” or “system” or “computer system” or “computing device” includes any data processing system including, but not limited to, personal computers, servers, workstation, network computers, main frame computers, routers, switches, Personal Digital Assistants (PDAs), telephones, and any other system capable of processing, transmitting, receiving, capturing and/or storing data.

What is claimed is:

1. A method comprising:
detecting movement of a portable computer;
comparing said detected movement of said portable computer to a predetermined threshold;
determining if said portable computer is coupled to a docking station; and
in response to determining said portable computer is coupled to said docking station, enabling security to secure data stored on said portable computer.

2. The method according to claim 1, wherein said portable computer is a laptop computer.

3. The method according to claim 1, wherein said portable computer is a personal digital assistant (PDA).

4. The method according to claim 1, further comprising:
determining if a correct password has been entered; and
in response to determining said correct password has been entered, disengaging said security.

5. The method according to claim 1, wherein said security is a screen lock and hardware password protection.

6. The method according to claim 1, wherein said detecting movement further includes:
detecting said movement of said portable computer utilizing a radio frequency identification (RFID) locator.

7. A system comprising:
a processor;
a data bus coupled to said processor;
a computer-usable medium embodying computer program code, said computer-usable medium being coupled to said data bus, said computer program code comprising instructions executable by said processor and configured for:
detecting movement of a portable computer;
comparing said detected movement of said portable computer to a predetermined threshold;
determining if said portable computer is coupled to a docking station; and
in response to determining said portable computer is coupled to said docking station, enabling security to secure data stored on said portable computer.

8. The system according to claim 7, wherein said portable computer is a laptop computer.

9. The system according to claim 7, wherein said portable computer is a personal digital assistant (PDA).

10. The system according to claim 7, wherein said instructions are further configured for:
determining if a correct password has been entered; and
in response to determining said correct password has been entered, disengaging said security.

11. The system according to claim 7, wherein said security is a screen lock and hardware password protection.

12. The system according to claim 7, wherein said instructions for detecting movement further include instructions configured for:
detecting said movement of said portable computer utilizing a radio frequency identification (RFID) locator.

13. A computer-usable medium embodying computer program code, said computer program code comprising computer-executable instructions configured for:
detecting movement of a portable computer;
comparing said detected movement of said portable computer to a predetermined threshold;
determining if said portable computer is coupled to a docking station; and
in response to determining said portable computer is coupled to said docking station, enabling security to secure data stored on said portable computer.

14. The computer-usable medium according to claim 13, wherein said portable computer is a laptop computer.

15. The computer-usable medium according to claim 13, wherein said portable computer is a personal digital assistant (PDA).

16. The computer-usable medium according to claim 13, wherein said computer-executable instructions are further configured for:
determining if a correct password has been entered; and
in response to determining said correct password has been entered, disengaging said security.

17. The computer-usable medium according to claim 13, wherein said security is a screen lock and hardware password protection.

18. The computer-usable medium according to claim 13, wherein said instructions for detecting movement further include computer-executable instructions configured for:
detecting said movement of said portable computer utilizing a radio frequency identification (RFID) locator.
